(19) United States
(12) Patent Application Publication
(10) Pub. No.: US 2025/0384422 A1
(43) Pub. Date: Dec. 18, 2025

(54) TRADE CREDIT DAILY VIRTUAL CARD

(71) Applicant: Multi Service Technology Solutions, Inc., Overland Park, KS (US)

(72) Inventors: Brandon Craig SPEAR, Overland Park, KS (US); Daniel Wayne ZIMMERMAN, Overland Park, KS (US)

(21) Appl. No.: 19/242,218

(22) Filed: Jun. 18, 2025

Related U.S. Application Data
(60) Provisional application No. 63/661,391, filed on Jun. 18, 2024.

(51) Int. Cl. G06Q 20/34; G06Q 20/10; G06Q 20/40; G06Q 40/03

(52) U.S. Cl. CPC G06Q 20/351; G06Q 20/102; G06Q 20/407; G06Q 40/03

(57) ABSTRACT

Aspects of this invention provide for allowing a buyer which has been issued trade credit to use that credit through an open loop payment network while maintaining payment terms of the trade credit. A parent account is generated for the buyer by a bank and the bank generates child accounts for the buyer. In an example 31 child accounts are generated with each child account being associated with purchases on a specific day in a calendar month. An order-to-cash platform manages a carousel of the child accounts under the parent account to ensure purchases are charged to the appropriate child account based on the trade credit terms and conditions.

### CROSS REFERENCE TO RELATED APPLICATIONS

This application claims priority to U.S. Provisional Application No. 63/661,391, filed on Jun. 18, 2024. The entire contents of which are incorporated herein in its entirety.

### BACKGROUND

Trade credit transactions are submitted to a trade credit manager or trade credit provider by businesses or merchants to request approval for those transactions prior to purchase. Each transaction requires the approval prior to purchase or funding of the purchase. This can be a drawn-out process that can be cumbersome for businesses and merchants to conduct efficient business.

### SUMMARY

At a high level, aspects described herein relate to systems and methods that process trade credit purchase approval from a credit manager using an open loop payment network. The present technological advance can resolve technological issues with traditional credit card purchases in a business-to-business context. Specifically contemplated is a trade credit purchase process that includes receiving, by an order-to-cash (OTC) platform, a request to authorize a purchase from a seller by a buyer, the buyer having a trade credit account with the OTC platform. The process continues with determining based on a query of a database, by the OTC platform, to which of a plurality of child accounts the purchase should be authorized and then communicating, from the OTC platform, a request for authorization of the purchase using an open loop payment system to a bank. The process continues with receiving, at the OTC platform, a set of transaction details for the authorized purchase and then automatically generating, by the OTC platform, based on the set of transaction details, an invoice. The invoices is then communicated to the buyer. The invoice may include rich details that would not normally be included in a credit card stile purchase.

This summary is intended to introduce a selection of concepts in a simplified form that is further described in the detailed description section of the present disclosure. It is neither intended to identify key or essential features of the claimed subject matter, nor is it intended to be an aid in determining the scope of the claimed subject matter. Additional objects, advantages, and novel features of the technology will be set forth in part in the detailed description that follows, and in part will become apparent to those skilled in the art upon examination of the present disclosure or learned through practice of the technology.

### BRIEF DESCRIPTION OF THE DRAWINGS

The present technology is described in detail below with reference to the attached drawing figures, wherein:

FIG. 1 is an example computing device suitable for implementing aspects of the present disclosure, in accordance with an embodiment described herein;

FIG. 2 is an example operating environment, in accordance with an aspect described herein;

FIGS. 3A-3E are example process flows that can be performed by components of the operating environment of FIG. 2 and the computing device of FIG. 1, in accordance with an aspect described herein;

FIG. 4 is an example operating environment, in accordance with an aspect described herein;

FIG. 5 is an example process flow for onboarding a buyer that can be performed by components of the operating environment of FIG. 4 and the computing device of FIG. 1, in accordance with aspects described herein; and

FIGS. 6A-6D are example process flows for completing a trade credit purchase managed by an order-to-cash platform in connection with an open loop network that can be performed by components of the operating environment of FIG. 4 and the computing device of FIG. 1, in accordance with aspects described herein.

### DETAILED DESCRIPTION

Merchant trade credit transactions are paid and authorized using invoices and other means of authorization. There is currently a need for a merchant trade credit user to be able to access the issued trade credit using an open loop payment network. Potential buyers seeking trade credit will complete a credit application equipped with flexible data fields and instant decisioning. Upon approval, purchasers will be provided a trade credit card for purchasing. This trade credit card will utilize an open loop payment network. The size of the credit line and the underlying risk will be supplied and managed by a credit manager or the entity that provided the credit. Cards can be either physical or virtual and will have a BIN range that is accepted at all existing merchant point-of-sale devices and ecommerce stores that accept open loop network payments.

Upon completing a purchase, buyers will be provided a detailed invoice including stock keeping unit (SKU)-level details for optimized reconciliation. Invoices can be populated/branded within a credit manager buyer portal or they can be generated and submitted directly to the buyer's systems for automated payments. This mechanism will provide business buyers with free working capital via the credit line and are relieved of rigid repayment options and cash flow constraints. Allowing buyers to pay on a net terms basis with a detailed invoice gives buyers greater transparency, which both helps eliminate fraudulent spending and creates an auditable process that promotes appropriate purchasing.

From the merchant (also referred to as the seller) perspective there is little to no additional work needed in order to enable their systems to accept this card type. The cost of acceptance will be similar to interchange on corporate credit cards. This system also eliminates the need for merchants to operate and maintain an in-house credit program, guaranteeing an improvement of day sales outstanding and eliminating risk/credit related write-offs.

The SKU-level data is sent from the merchant to the credit manager in a number of ways as described herein. This SKU-level data will be used to populate any invoice sent to the buyer or purchaser. The merchant could also pass on level III data (e.g., merchant specified line item details at the time of purchasing an item or service beyond that is minimally required for traditional credit card transactions) at the point of purchase. This can be accomplished either through the card networks, credit manager application programming interfaces (APIs), or via receipt systems. The merchant would be able to select the option that best fits their needs.

In an example, the SKU-level data may also include information related to Value Added Tax (VAT). Having specific VAT information included in invoices provides an opportunity for the buyer to reduce taxation in some jurisdiction. To take advantage of the reduced taxation (or limitation on double taxation) the VAT amount should be included in an invoice. Traditional credit card transactions fail to capture VAT amounts and therefore traditional credit card transactions and the resulting statements are generally not sufficient for limiting taxation in response to VAT amount. As such, it is contemplated that SKU-level data may also include VAT amounts (or the like).

In some aspects, a merchant may be a buyer, a seller, or any other business or personal entity. In one embodiment, the merchant entity may be a seller. The seller may be any corporate, commercial, charitable, religious, non-profit, and/or other entity (including commercial buyer's employees, agents, or other authorized persons) that sells goods or services to a buyer/purchaser/buyer. In an alternative embodiment, the buyer may be a purchaser. The purchaser may be any corporate, commercial, charitable, religious, non-profit, and/or other entity (including commercial buyer's employees, agents, or other authorized persons) that buys goods or services from the seller. Additionally, in some aspects the acquirer may be related to the merchant or the merchant itself.

In additional aspects, an issuer processor is a type of financial institution that acts as a go-between for merchants and cardholders. The processor facilitates the approval and processing of credit and debit card transactions. Issuer processors are also sometimes referred to as acquirers or payment processors. It is noted, however, that a payment processor may be distinct and separate from an acquirer. The functions of each may be combined or separated in aspects.

An open loop payment network includes at least one open loop universally accepted credit card, debit card or mobile payment processing network that is an internationally identified financial card or mobile payment service, typically under trademarks such as VISA™, MASTERCARD™, AMERICAN EXPRESS™, DISCOVER™, DINERS CLUB™, JCB™ (accepted in Japan), UNION PAY™ (accepted in China) and the like. These are international (universal) networks which enable hundreds of millions of payers or mobile phone subscribers to purchase goods and services at millions of merchant locations. Furthermore, funding rules, returns, fraud coverage and consumer protection governance are stringent and rarely changed. While interest and surcharge rates can be changed frequently, how a merchant authorizes and settles (deposits) funds at their bank is very well defined and rarely modified.

Relative to existing technologies and computer functionality, the methods of the present disclosure reduce network latency, reduce packet generation costs, and reduce computer input/output (I/O), among other computer function benefits. This is because particular embodiments reduce the number of hardware components that need to be contacted, over a computer network, at a credit application processor, since the communication with the external sources occurs using a single service or a server rather than multiple services or servers at a time. What this means is that fewer (or no) packets have to be generated and sent over the computer network. Each time a service is contacted, for example, contents or payload of the request is typically supplemented with header information or other metadata within a packet in TCP/IP or other protocol networks. Accordingly, when this functionality is multiplied by all the services needed to obtain the desired data, there are network latency costs by repetitively generating the metadata and sending it over the computer network. However, as described above, communication with external sources occurs using only the single service or the server, which means there are fewer packets to generate and fewer messages to traverse the computer network, thereby reducing network latency. This has a further technical effect of decreasing the computer I/O. With respect to the existing technologies, continuous communication with multiple services increases storage device I/O (for example, excess physical read/write head movements on non-volatile disk) because, with each communication or data packet sent, a computing system has to reach out to the storage device I/O to perform a read or write operation, which is error prone, and eventually wears on components, such as a read/write head. When multiplied by all the multiple service communication requirements, this causes excessive wear on the read/write head and causes excessive energy consumption and heat, which leads to other computational issues, such as memory errors. However, as described above, there are fewer (or no) times that embodiments perform I/O. Consequently, there is not as much wear and tear on the read/write head, and there is not as much energy consumption and heat generation, and hence the likelihood of memory errors is reduced.

Additionally, in some embodiments, the methods of the present disclosure improve computer security relative to existing technologies because the external sources are contacted and accessed using the single service rather than multiple services. In other words, more the number of times a data packet has to traverse the computer network (which occurs with existing technologies), higher the likelihood that data will be sniffed or otherwise compromised. Sniffing is a process of monitoring and capturing all data packets passing through a given network. Attackers use sniffer code to capture data packets containing sensitive information, such as password, account information, and the like. However, as described above, some embodiments only use the single service rather than multiple services, which means there are less packets getting transmitted over the computer network, which consequently means that the data is less likely to be sniffed by attackers. The centralized integration service is also easily modifiable to adapt to changing external source code or systems since the centralized integration service is built based on the volatility-based decomposition architecture that allows for only a portion of the architecture to be changed at a time.

This fragmented approach extends to invoice financing technologies, resulting in substantial time consumption, incomplete information, and the application of a considerable amount of effort, impeding the swift and effective planning and execution of financial operations. The lack of a unified platform that gathers all pivotal invoice financing data in one centralized location—for example, a single user interface page—exacerbates these inefficiencies, introducing potential delays and operational stagnations. Moreover, consolidating comprehensive information into a unified format or user interface that is easily navigable represents a crucial technological advancement over the existing systems. It would not only streamline operations but also foster a more intuitive and user-friendly environment, wherein individuals and institutions can make informed decisions swiftly, leveraging the aggregated data and insights at their fingertips. This represents a marked departure from the current state of affairs, ushering in a new era of efficiency and intelligence in invoice financing technologies.

Leveraging data from a variety of sources and centralizing it into a singular, standardized format or user interface substantially elevates the present technology, enriching the efficacy, precision, and interoperability of information management in the invoice financing sphere. This consolidation into a unified format or interface not only smoothens the pathway for data integration and analysis but eradicates inconsistencies spawned from managing diverse data structures and types. This transformative step facilitates the fluid exchange of information across different platforms and applications, nurturing real-time collaborative decision-making. For stakeholders in invoice financing, including applicants and financial institutions, this innovation means rapid and unencumbered access to essential data concerning loan offerings, applicant histories, and credit terms. This centralization lays the ground for more precise comparisons, trending analyses, and forecasts, enhancing the overall quality of financial planning and operations in the sector. Thus, the unified data format emerges as a technological linchpin, forging connections between various data reservoirs and augmenting the operability and usability of invoice financing systems. It aims to engender a more streamlined and intelligent approach to data handling, thereby standing to significantly revolutionize the invoice financing landscape.

Operationally, the technical solution supports automated trade credit purchases through an order-to-cash (OTC) platform. The process begins with receiving a purchase authorization request from a buyer who holds a trade credit account. The OTC platform queries a database to determine the appropriate child account—from a set of accounts (e.g., 31, each tied to a different day)—to authorize the purchase. The system then sends an authorization request to a bank via an open-loop payment system. Once the bank approves, the OTC platform receives transaction details, such as SKU-level and tax information, and uses this data to automatically generate an invoice. The invoice, which may include a reference number and itemized details, is communicated to the buyer and may also be used by the bank for billing. Additional features include credit application intake, bank underwriting, buyer-specific authorization rules, dispute handling, and chargeback initiation, ensuring end-to-end automation of trade credit transactions.

In this way, the technical solution implements a specific, non-abstract improvement to a traditional commercial process—automating trade credit purchases using a technical platform. While finance-related, the technical solution goes beyond an abstract idea by reciting a concrete series of computer-implemented steps involving specific data flows, account structures and integration with external systems like banks and open-loop payment networks. The technical solutions solves a real-world problem: the complexity of managing trade credit across variable billing cycles, dynamic account assignment, and SKU-level invoicing. The claimed features, including automated account routing, real-time bank communication, and detailed invoice generation, are not merely routine data processing but instead offer a technological solution that improves the functionality of financial transaction systems.

By way of example, consider a B2B e-commerce scenario in which a construction supply retailer, Acme Tools, offers trade credit to buyers through an automated order-to-cash (OTC) platform. A customer, BuildCo, selects $25,000 worth of tools on Acme's platform and chooses to pay using its trade credit account. Upon receiving the purchase request, the OTC platform queries its internal database to determine which of BuildCo's 31 child accounts—each mapped to a specific day of the month—should be used to authorize the purchase. Based on the date and the buyer's 30-day payment terms, the system automatically assigns the purchase to the child account for the 10th of the month. The OTC platform then generates a payment authorization request and sends it to Acme's partnering bank using an open-loop payment system such as VisaNet. Once the transaction is authorized, the bank responds with confirmation and transaction details.

The OTC platform then automatically generates an invoice using SKU-level data, including item descriptions, quantities, taxes, and a unique invoice reference number. This invoice is sent electronically to BuildCo and, simultaneously, the reference number is transmitted to the bank for inclusion in BuildCo's monthly statement. The entire process—from credit validation to account routing, authorization, invoicing, and bank coordination—is performed automatically by the OTC platform without manual intervention.

This implementation goes far beyond a generic financial concept and instead demonstrates a specific, inventive use of computing systems to solve a technical problem in trade credit management. By integrating real-time payment authorization, dynamic account selection, and structured invoicing, the system improves the functionality of computer-based financial infrastructure

It will be realized that the method previously described is only an example that can be practiced from the description that follows, and it is provided to understand the technology and recognize its benefits. Additional examples are now described with reference to the figures.

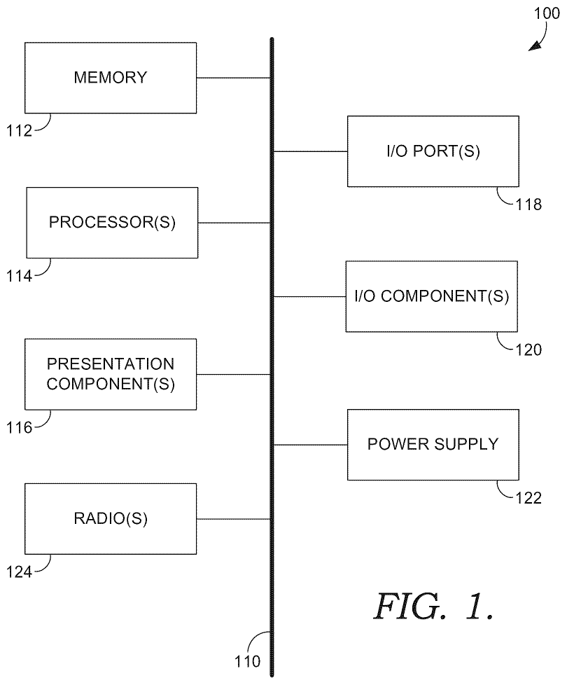

With initial reference to FIG. 1, the computing device 100 includes a bus 110 that directly or indirectly couples the following devices: the memory 112, one or more processor(s) 114, one or more presentation component(s) 116, input/output port(s) 118, input/output components 120, and illustrative power supply 122. The bus 110 represents what may be one or more busses (such as an address bus, data bus, or a combination thereof).

Although the various blocks of FIG. 1 are shown with lines for the sake of clarity, in reality, delineating various components is not so clear, and metaphorically, the lines would more accurately be grey and fuzzy. For example, one may consider a presentation component, such as a display device, to be an I/O component 120. As another example, processor(s) 114 may also have memory. Such is the nature of the art, and it is again reiterated that the diagram of FIG. 1 merely illustrates an example computing device that can be used in connection with one or more embodiments of the present disclosure. Distinction is not made between such categories as “workstation,” “server,” “laptop,” “hand-held device,” “point-of-sale device,” “mobile device” etc., as all are contemplated within the scope of FIG. 1 and reference to the “computing device.”

The computing device 100 typically includes a variety of computer-readable media. The computer-readable media can be any available media that can be accessed by the computing device 100 and includes both volatile and nonvolatile media, and removable and non-removable media. By way of non-limiting example, the computer-readable media may comprise computer storage media and communication media.

The computer storage media includes volatile and nonvolatile media, removable and non-removable media implemented in any method or technology for storage of information, such as computer-readable instructions thereon, data structures, program modules or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium that can be used to store the desired information that can be accessed by the computing device 100. The computer storage media excludes signals per se.

The communication media typically embodies computer-readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information associated therewith. By way of non-limiting example, the communication media includes wired media, such as a wired network or direct-wired connection; and wireless media, such as acoustic, RF, infrared, and other wireless media. Combinations of any of the above should also be included within the scope of computer-readable media.

The memory 112 includes computer storage media in the form of volatile or nonvolatile memory. The memory 112 may be removable, non-removable, or a combination thereof. Example hardware devices include solid-state memory, hard drives, optical-disc drives, etc. The computing device 100 includes one or more processor(s) 114 that read data from various entities, such as the memory 112 or the I/O components 120. The presentation component(s) 116 present data indications to a user or other device. Examples of the presentation component(s) 116 include a display device, speaker, printing component, vibrating component, etc.

The I/O port(s) 118 allow the computing device 100 to be logically coupled to other devices including the I/O components 120, some of which may be built in. Illustrative components include a microphone, joystick, game pad, satellite dish, scanner, printer, wireless device, and the like.

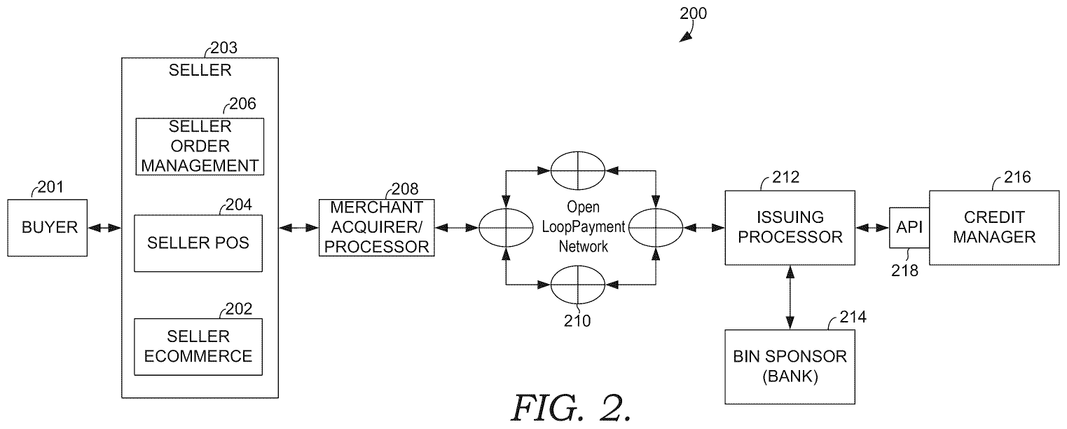

With reference now to FIG. 2, which is an example operating environment 200 in which aspects of the present disclosure can be employed to process and authorize a payment with respect to an open loop payment network. As illustrated, the operating environment 200 comprises a business buyer 201, a seller 203 having a seller ecommerce 202 (e.g., seller ecommerce portion), a seller point-of-sale (i.e., POS) 204 and a seller order management 206. The operating environment 200 also includes a merchant processor 208, an open loop payment network 210, an issuing processor 212, a BIN sponsor 214, a credit manager 216, and API 218.

The components may all be connected through a network. The network may include one or more networks (for example, public network or virtual private network “VPN”). In a non-limiting example, the network may include one or more local area networks (LANs), wide area networks (WANs), or any other communication network or method. Each of the components in FIG. 2 may communicate directly or indirectly with other components through the network.

The operating environment 200 further comprises a data store (not explicitly depicted). The data store generally stores information including data, computer instructions (for example software program instructions, routines, or services), or models used in the embodiments of the present disclosure. Although discussed as a single data store component, the data store is embodied as one or more data stores or is in the cloud or other distributed architectures. One example suitable for use as the data store is memory discussed with reference to FIG. 1.

The data store may include one or more storage devices configured to collect, store, delete, update, and/or modify data in accordance with one or more instructions received from one or more other components, the user serve. For example, the data store may include any suitable combination of one or more storage mediums, such as hard disk drives, solid state memory, cloud-based storage devices, etc. In various aspects, the data store may store data in addition to or instead of data stored locally by the user server. In doing so, the user server and any other server, the data store, and/or other back-end components may store any suitable type of data used to facilitate various functionalities of certain aspects as described herein.

Having identified various components of the operating environment 200, it is emphasized that any additional or fewer components, in any arrangement, may be employed to achieve the desired functionality and are within the scope of the present disclosure. Although, the various components of FIG. 2 are shown with lines for the sake of clarity, the lines can illustrate a direct path of communication from one component to another or may represent a path where other intermediary components are present.

While the components of FIG. 2 are depicted as single components, the depictions are intended as examples in nature and in number and are not to be construed as limiting for all implementations of the present disclosure. Other arrangements and elements (for example machines, interfaces, functions, orders, and groupings of functions, etc.) can be used in addition to or instead of those shown, and some elements may be omitted altogether. Therefore, for the sake of brevity and clarity, when the components of FIG. 2, or any other figure, are referred to in singular, it is intended to include functions performed by one or more components working together.

The functionality of the operating environment 200 can be further described based on the functionality of the described components. That is, many of the components described in relation to FIG. 2 are entities that perform functions. Various functions described herein are being performed by one or more components and may be carried out by a hardware, a firmware, and/or a software. That is, functions performed by the components of FIG. 2 can be performed by executing computer-executable instructions stored in memory, such as the data store.

Building from the description below for FIG. 2, the present disclosure contemplates the buyer 201 desiring to purchase a good or service from the seller 203. The buyer 201 desires to buy the goods/services on trade credit using a traditional credit card-like experience. The buyer 201 also desires to have itemized invoices for the purchase while still having the convenience of the traditional credit card style purchase. The itemized invoice, for example, may include a much greater level of details about the purchase than is traditionally provided with a traditional credit card style transaction.

Further, the seller 203 may also desire for the buyer 201 to be able to complete the purchase in a traditional credit card style transaction while offering trade credit to the buyer 201. The seller 203 also may desire to set the terms of the trade credit, such as a net terms agreement that dictates the entire amount purchased will be paid in full at a certain date, such as one month from the purchase. Unfortunately, traditional credit card style transactions instead aggregate purchases over a period of time (e.g., a month) and then provides a statement for the aggregated purchases with a future payment (e.g., the following month). This delayed statement and payment can extend the time from purchase to payment on average 45 days, which can be beneficial for the buyer 201, but the BIN sponsor 214 is carrying, on average, the costs of the purchase for a longer time than may be desired. This extended time increases the costs for the seller 203 to offer credit extended from the BIN sponsor 214 to the buyer 201.

As such, the seller 203 benefits from a trade credit approach where a daily purchases by the buyer 201 are invoiced in the near future (e.g., same day, next day) with payment due at a predetermined time from the purchase (not from the statement), such as 30 days, one months, 45 days, 60 days, 3 months, etc. Trade credit approach is also advantageous to the buyer 201 as it can provide a one-to-one invoicing to purchase association, provides for enhanced reconciliation, provides for a daily updated credit line availability all while having the convenience of a traditional credit card transaction—all of which will be discussed in greater detail hereinafter.

In general, a processor (not a computing processor, but a processor in the financial transaction sense), such as the merchant processor 208, may operate with computer-readable media. The merchant processor 208 executes instructions on the computer-readable media. The merchant processor 208 operates to facilitate the sale and processing of purchases made by a user or a customer, such as buyer 201, which has been authorized to access merchant credit by the credit manager 216. The merchant processor 208 facilitates the operation of the seller order management 206, the seller POS 204, and the seller ecommerce 202. The seller ecommerce 202, seller POS 204 and seller order management 206 operate to allow the buyer to be able to use the open loop payment network 210 and the trade credit provided by the credit manager 216 to be able to purchase items or services on trade credit rather than consumer credit or business credit that is billed one-monthly without invoices. The seller order management 206 provides order management, bills of sale, SKU data, settlement files, approval requests, purchase orders, and many other operations.

The open loop payment network 210 is used to facilitate the transfer of funds from the issuing processor 212 and the BIN sponsor 214 to a merchant, such as seller 203, relying on the merchant processor 208. A BIN sponsor, such as the BIN sponsor 214, is responsible for issuing BIN ranges associated with a payment card, which are generally the first six numbers on a payment card that identify the bank which issued the payment card of the 8 digits. The user, such as the buyer 201, of the trade credit will hold an account or card associated with the open loop payment network 210. This account will be used to process transactions at the seller POS 204 and/or the seller ecommerce 202 (i.e., seller electronic commerce). By having an open loop payment network associated with the user's trade credit issued by the credit manager 216, the user is able to have trade credit terms associated with an open loop payment network 210 account.

The credit manager 216 is operated, in an example, by initially issuing trade credit on open terms and trade credit terms. This may be done using industry standard methods. Once the credit manager 216 issues the trade credit to the buyer 201, an account is opened and a parent card or account is set-up with the open loop payment network 210. Under the parent card or account, a defined number of sub accounts are opened under the parent account. It is contemplated that 31 sub accounts are opened such that a sub account exists for each possible day in a month. The parent account and the sub accounts are created to allow the user to access the issued trade credit using traditional open loop payment network 210 methods. In other aspects, the BIN sponsor 214 issues a card or account that is useable by the merchant acquirer/processor 208 for associating a purchase to one or more sub accounts based on the date of the related purchase. The issuing processor 212 will be backed or supported by the BIN sponsor 214, which will fund transactions made through the open loop payment network 210 by the user (e.g., buyer 201) of the issued trade credit. The credit manager 216 will also approve requested transactions by determining if there is available credit for the user. Once the transaction has occurred, the credit manager 216, in an example, will request bills of sale, itemized details, or other information useful for detailing the underlying transaction from the seller 203. The credit manager 216 will manage and request payment by the user according to the agreed upon trade credit terms.

As used in FIG. 2 and throughout this disclosure, the seller, such as seller 203 in FIG. 2, includes a plurality of features/functions/entities. It is understood that each of those, such as the seller order management 206, seller POS 204, and seller ecommerce 202 may be separate and distinct entities/functions/features all with the purpose of serving the interest of the seller 203.

The technology of the present disclosure is described in the general context of computer code or machine-useable instructions, including computer-executable instructions, such as program modules, being executed by a computer or other machine, such as a personal data assistant or other handheld device. Generally, the program modules including routines, programs, objects, components, data structures, etc., refer to a code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

### Trade Credit Accessing the Open Loop Payment Network

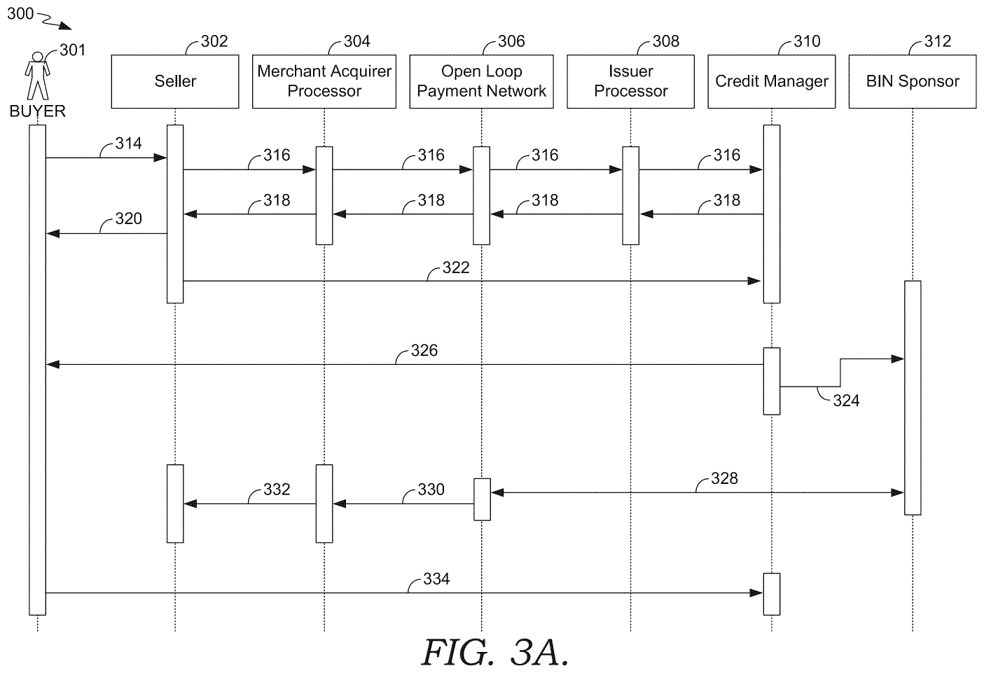

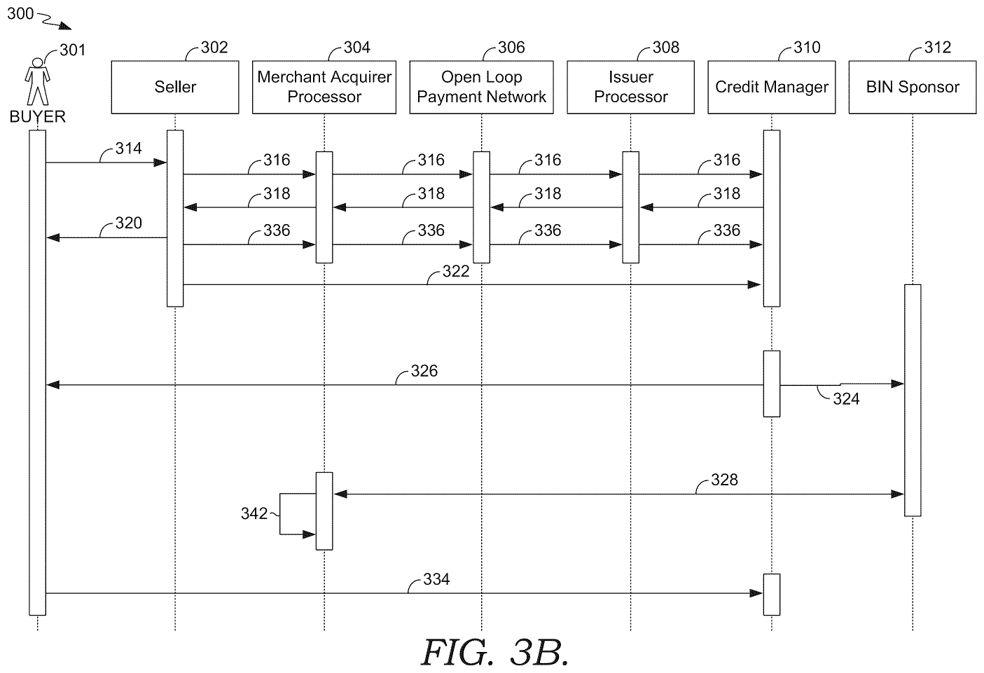

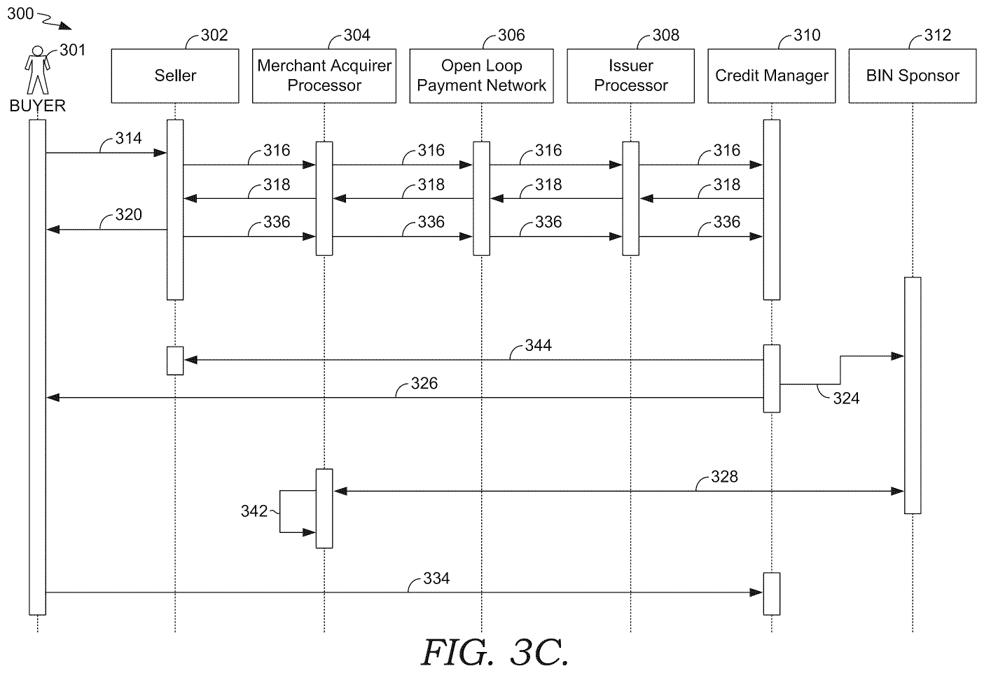

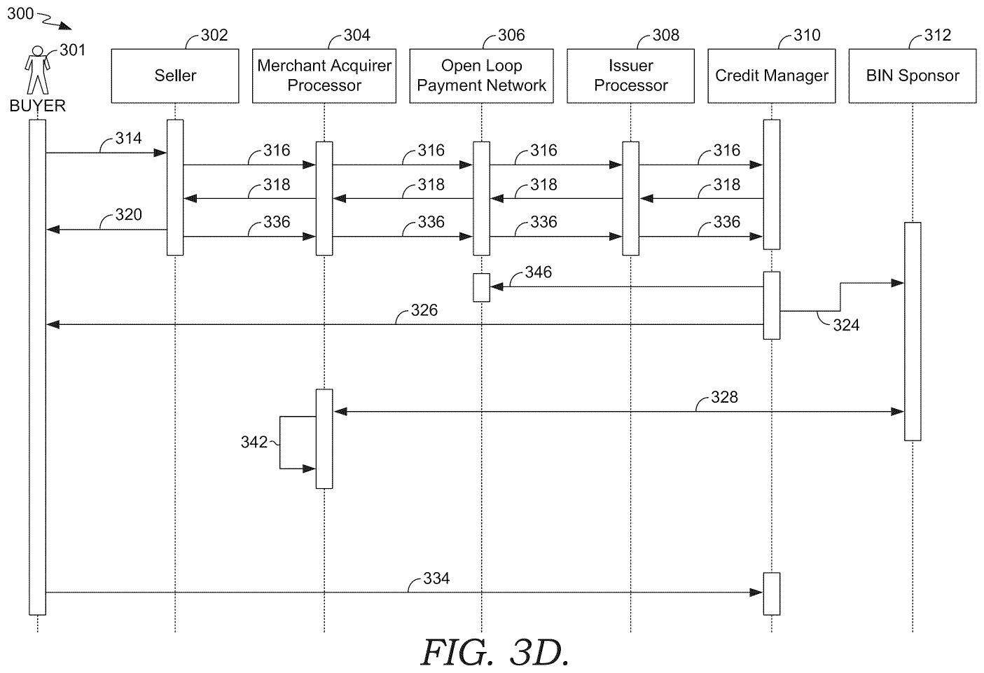

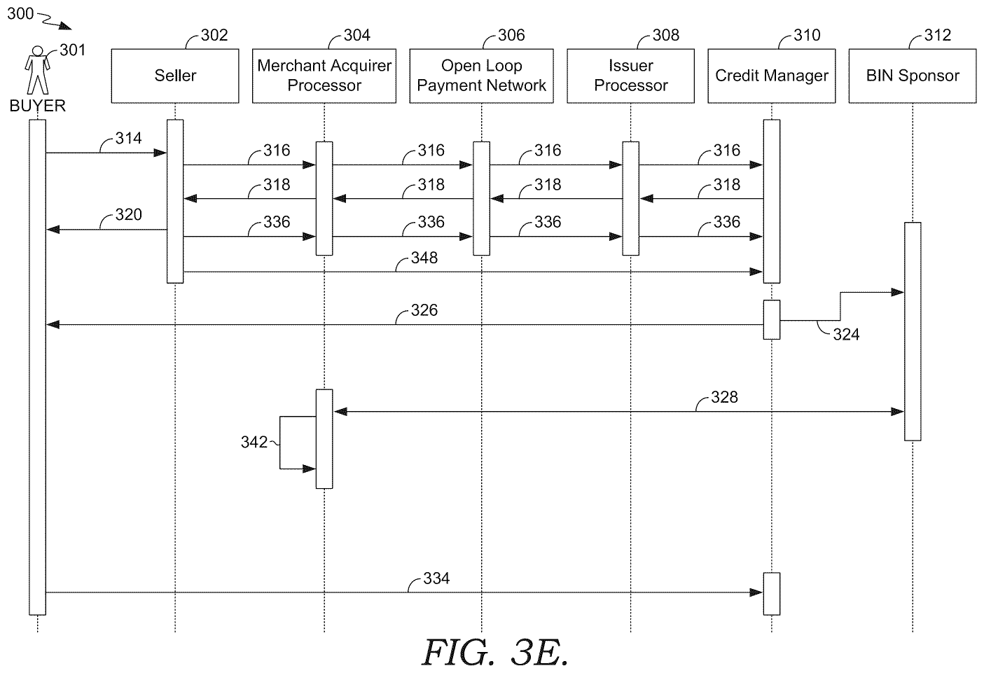

Referring now to FIGS. 3A-3E, which contain an example operating environment 300 with alternative methods of being utilized for processing and approving a trade credit purchase, in accordance with aspects provided herein. It should be understood that the operating environment 300 is an example that can be performed using the current technology, and that other processes for processing and approving the trade credit purchases and variations of the operating environment 300 are contemplated but are not discussed in detail for brevity. The operating environment 300 can be performed by the components of FIG. 1 and provides many of the benefits and advantages discussed herein. As illustrated, the operating environment 300 comprises a buyer 301, a seller 302, a merchant acquirer processor 304, an open loop payment network 306, an issuer processor 308, a credit manager 310 and a BIN sponsor 312.

Having identified the various components of the operating environment 300, it is emphasized that any additional or fewer components, in any arrangement, may be employed to achieve the desired functionality and are within the scope of the present disclosure. Although, the various components of FIGS. 3A-3E are shown with lines for the sake of clarity, the lines can illustrate a direct path of communication from one component to another or may represent a path having other intermediary components. Further, as discussed above the various components of the operating environment 300 may communicate through one or more networks, directly or indirectly, as provided herein. The buyer 301 is depicted in connection with FIGS. 3A-3E. The buyer 301 is a purchaser of goods and/or services. The buyer 301 in some examples is a commercial entity, such as a business. The buyer 301 may also be an individual, in some examples.

While the components of FIG. 3A-3E are depicted as single components, the depictions are intended as exemplary in nature and in number and are not to be construed as limiting for all implementations of the present disclosure. Other arrangements and elements (for example machines, interfaces, functions, orders, and groupings of functions, etc.) can be used in addition to or instead of those shown, and some elements may be omitted altogether.

Beginning with FIG. 3A, the buyer 301 in one aspect is approved by the credit manager 310 to be issued trade credit. Such trade credit is a business-to-business agreement in which the buyer 301 is able to purchase goods and/or services from the seller 302 using the open loop payment network 306 with a card/account issued by the issuer processor 308. The transactions are backed by a BIN sponsor. In one aspect, the BIN sponsor is a sponsoring bank, such as BIN sponsor 312. The buyer 301 is able to purchase goods and services from the seller 302 and pay at a later time through the recorded transaction while still allowing the seller 302 to be paid by the BIN sponsor 312. The buyer 301 may request to purchase goods or services at step 314 from the seller 302. This request to purchase is done using an approved card or account number issued using the buyer's 301 trade credit account. The issuer processor 308 issues a card that has access to the open loop payment network 306. Once the request to purchase at step 314 is made at the seller 302, the seller 302, also referenced as a merchant herein, requests authorization for trade credit to be used in the transaction at step 316. Traditionally, in consumer credit approvals, the issuer processor 308 approves the trade credit. However, in accordance with the present disclosure, the credit manager 310 (i.e., the issuer of the trade credit) approves the transaction requesting the trade credit access. Trade credit allows the buyer 301 to pay on a revolving debt basis on 30, 60, 90-day terms, or any other terms agreed to between the buyer 301 and the credit manager 310 and the seller 302. As such, the credit manager 310 maintains a log or dataset associated with the issued trade credit and is able to determine if there is sufficient credit available for the requested purchase. Once the credit manager 310 determines there is sufficient credit, an approval notification is sent via step 318 by way of the issuer processor 308, the open loop payment network 306, the merchant acquirer processor 304, and the seller 302. The seller 302 then fulfills the purchase at step 320.

At step 322, the seller 302 sends SKU-level data to the credit manager 310. The SKU-level data may include, but is not limited to, item/service description, item/service identifier, number ordered, and other details about the purchase. The SKU-level data may include data that would be found on an invoice that is typically provided for a trade credit type purchase. The SKU-level data may be sent via any electronic or other means. The credit manager 310 (or other components in the operating environment 300) may request the SKU-level data or the seller 302 may automatically send the SKU-level data. In addition to SKU data, the system may send an itemized list of purchased items or services.

At step 324, the credit manager 310 requests funding from the BIN sponsor 312, sometimes referred to as daily funding. The credit manager 310 maintains a log of all purchases approved for the covered period of time (e.g., the day) and requests transfer for the funds to satisfy those purchase obligations. This request to fund all transactions during the covered time period occurs at step 324. At step 326, credit manager 310 communicates the funding of transactions to the buyer 301 by way of an invoice or bill. The funds are transferred from the BIN sponsor 312 at step 328 to the open loop payment network 306 as an intermediary to pay off the debts supported through that network. The open loop payment network 306 is then used to pay the merchant acquirer processor 304 at step 330 and also pays the seller 302 at step 332. At step 326, the credit manager 310 will send the buyer 301 an invoice based on the purchase, the SKU-level data, and/or the payment terms. At step 334, the buyer 301 pays the invoice to the credit manager 310 which then in turn uses those funds to satisfy the credit issued and the BIN sponsor 312 backed funding.

As can be appreciated, FIG. 3A provide an example of the flow of information/data/funds/requests/communications between the components in the operating environment 300 to support a trade credit transaction with the credit manager 310 and a buyer 301 over an open loop payment network. Additional approaches are contemplated here, such as those illustrated in connection with operating environment 300 in other examples.

Moving now to FIG. 3B which incorporates all portions described in FIG. 3A while illustrating an alternative methodology of implementation in connection with the operating environment 300, in accordance with an aspect herein. At step 326, the seller 302 sends a settlement file to the credit manager 310 by way of the merchant acquirer processor 304, the open loop payment network 306, and the issuer processor 308. The settlement file includes information related to the purchase and the bank settlement of payment. The BIN sponsor 312, based on the settlement file, may pay the merchant acquirer processor 304 directly at step 328, which will then deposit funds to satisfy the purchase into the bank account of the seller 302. The settlement file that is sent at step 326 can include information related to the payment of the merchant bank account at step 342 by the merchant acquirer processor 304. This may include date paid, date amount paid, any disputes by the seller 302, and/or any other information related to the purchase, payment, transaction information, a seller 302 uniform resource locator (URL), transaction ID, and the like.

Moving now to FIG. 3C, which incorporates all portions described in FIG. 3A-3B while illustrating an alternative methodology of implementation in connection with the operating environment 300, in accordance with an aspect herein. In FIG. 3C at step 344, the credit manager 310 may inquire directly to the seller 302 to retrieve the SKU-level data. In response to the request at step 344, a URL (or other reference specific to the desired SKU-level data) may be provided by the seller 302 to the credit manager 310. The credit manager 310 is able to use that URL/reference and information contained in the settlement file sent at step 336 to access information related to transactions performed by the seller 302. The URL may require that the credit manager 310 input transaction specific data in order to access specific transactions. That data may be date, time, location, transaction ID, Value Added Tax (VAT) information, buyer 301 name, buyer 301 number, buyer 301 account information, or other transaction specific information. The URL may also be transaction specific and go directly to a location that contains SKU-level information that the credit manager 310 requires and has access.

Moving now to FIG. 3D, which incorporates all portions described in FIG. 3A-3C while illustrating an alternative methodology of implementation in connection with the operating environment 300, in accordance with an aspect herein. At step 346, the credit manager 310 may use the data sent by the settlement file in step 336 to query the open loop payment network 306. The open loop payment network 306, in some aspects, maintains a record of transactions and SKU-level data related to the transaction. Instead of querying the seller 302, the credit manager 310 can collect the information from the open loop payment network 306. This alternative to requesting the date from the seller 302 may save resources and reducing queries of the seller 302. For example, if the open loop payment network 306 already has the required data, it may be more efficient to request the data from the open loop payment network 306 instead of from the credit manager 310. In some instances, this information is collected by the open loop payment network 306 directly with the transactions as an additional data field during the transaction.

Moving now to FIG. 3E, which incorporates all portions described in FIG. 3A-3D while illustrating an alternative methodology of implementation in connection with the operating environment 300, in accordance with an aspect herein. The seller 302 implements a procedure to send SKU-level data at step 348 directly to the credit manager 310, such as through an API or similar function. In this example, the communication of data via an API may be in addition to the settlement file sent in step 336. The seller 302 may have a relationship or authorization to use the open loop payment network 306 and the credit manager 310. For example, the seller 302 may be approached by the open loop payment network 306 and asked to provide the SKU-level information and the settlement file for each transaction that uses the credit manager 310 approval process. This information may be provided to the open loop payment network 306 and/or directly to the credit manager 310. Alternatively, the SKU-level data at step 348 may be provided from the seller 302 to the credit manager 310 using alternative networks than that used for the settlement file, such as not passing through the open loop payment network 306.

### Trade Credit Virtual Card

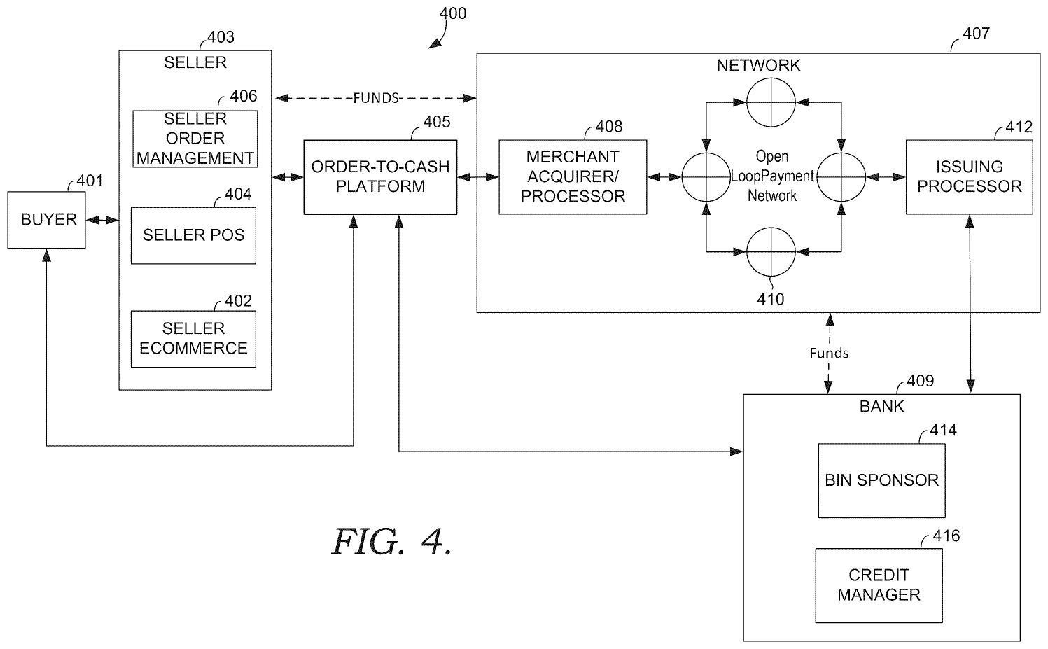

Referring now to FIG. 4 that depicts an example operating environment 400 in which aspects of the present disclosure can be employed to process and authorize a payment with virtual cards in connection with an open loop payment network, in accordance with aspects hereof. The elements of operating environment 400 relate to similarly named elements from FIG. 2 and incorporate the same disclosure already provided herein. For example, the buyer 201 of FIG. 2 and the buyer 401 of FIG. 4 are comparable and the disclosure of buyer 201 is imputed to buyer 401. As illustrated, the operating environment 400 comprises a buyer 401, a seller 403 having a seller ecommerce portion 402, a seller point-of-sale (i.e., POS) 404 and a seller order management 406. The operating environment 400 also includes a merchant processor 408, an open loop payment network 410, an issuing processor 412, and a bank 409 having access to a BIN sponsor 414 and a credit manager 416. The operating environment also includes an order-to-cash (OTC) platform 405.

The OTC platform 405 serves as a conduit for information, decisioning, and dispute coordination in a trade credit virtual card operation over an open loop payment network. As will be discussed in greater details hereinafter with FIGS. 4-6E, the OTC platform 405 onboards a buyer to a trade credit program, configures terms and conditions for the buyer's access to a specific seller's environment, provides coordination for a bank to underwrite the buyer, calculates an invoice date for a specific purchase, determines a virtual card to apply a purchase, manages levels of authentication for the buyer, receives SKU-level data from the seller, generates an invoice for the buyer related to the purchase, and manages invoice disputes between the buyer and seller at an invoice level. This all allows for a seller to offer goods and service for purchase using a traditional credit card-style transaction over an open loop payment network while maintaining traditional trade credit and traditional payment terms for trade credit purchases. The OTC platform 405 operates with computer readable media on a computing system, such as that disclosed in FIG. 1, to accomplish the features, functions, optimizations, transformations, and efficiencies provided herein.

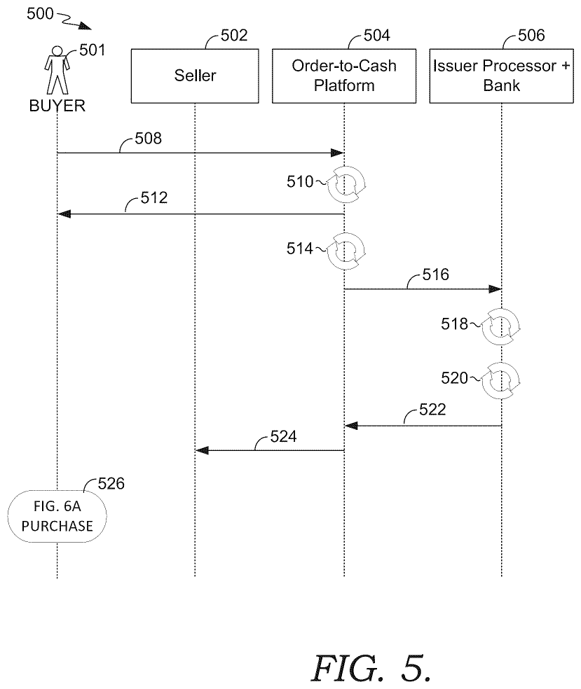

Referring now to FIG. 5 that depicts an example operating environment 500 with a method of onboarding a buyer for a trade credit program having virtual cards and a traditional credit card buying experience, in accordance with aspects provided herein. It should be understood that the operating environment 500 is an example that can be performed using the current technology, and that other processes for onboarding a buyer to a trade credit platform and variations of the operating environment 500 are contemplated but are not discussed in detail for brevity. The operating environment 500 can be performed by the components of FIG. 1 and provides many of the benefits and advantages discussed herein. As illustrated, the operating environment 500 comprises a buyer 501, a seller 502, an OTC platform 504, and an issuer processer/bank (referred to as an “IPB” hereinafter) IPB 506.

Having identified the various components of the operating environment 500, it is emphasized that any additional or fewer components, in any arrangement, may be employed to achieve the desired functionality and are within the scope of the present disclosure. Although, the various components of FIG. 5 are shown with lines for the sake of clarity, the lines can illustrate a direct path of communication from one component to another or may represent a path having other intermediary components. Further, as discussed above the various components of the operating environment 500 may communicate through one or more networks, directly or indirectly, as provided herein. The buyer 501 is depicted in connection with FIG. 5. The buyer 501 is a purchaser of goods and/or services. The buyer 501 in some examples is a commercial entity, such as a business. The buyer 501 may also be an individual, in some examples.

While the components of FIG. 5 are depicted as single components, the depictions are intended as exemplary in nature and in number and are not to be construed as limiting for all implementations of the present disclosure. Other arrangements and elements (for example machines, interfaces, functions, orders, and groupings of functions, etc.) can be used in addition to or instead of those shown, and some elements may be omitted altogether.

The process depicted in FIG. 5 represents an onboarding process for the buyer 501. In an example, the buyer 501 may be a corporation that is in the market to buy new computers for its employees. The buyer 501 desires to buy the computer through the seller 502. The seller 502 is willing to provide favorable pricing to the buyer 501 in return for a large sale of computers to the buyer 501. However, at the same time, the buyer 501 is interested in completing the purchase of computers, in this non-limiting example, from the seller 502 using a traditional credit card style of transaction. Unlike a traditional credit card style transaction, the buyer 501 also desires to have detailed invoices that include SKU-level details, which are not traditionally included or available for a historic credit card style purchase. Further, the seller 502 desires to offer the terms on net terms that limits the financing costs associated with the computer purchase relative to a traditional credit card style transaction. As such, the buyer 501 and the seller 502 each find benefits in engaging in a trade credit transaction leveraging a traditional credit card style purchase approach.

The buyer 501 applies for an account with the OTC platform 504 and communicates the data associated with the account application at a step 508. The application may be provided to the buyer 501 from the OTC platform 504 and/or an invitation from the seller 502. The application may be completed through a digital portal or other comparable structures. The OTC platform 504 reviews the application data received from step 508 and determines to provide approval for the buyer 501 at a step 510. The approval is communicated from the OTC platform 504 to the buyer 501 at a step 512. This approval process may be based on a number of factors established by the OTC platform 504 or in combination with the seller 502.

The OTC platform 504 configures the terms and conditions in the OTC platform 504 systems at a step 514. The terms and conditions include traditional trade credit terms and conditions, such as the number of days the seller 502 has agreed are offered for the buyer 501 to pay the statement associated with a purchase. The seller 502 has the ability to configure the terms through a portal available to the seller 502 on the OTC platform 504 system. This allows for updates and changes to the trade credit framework negotiated between the buyer 501 and the seller 502 while having aspects of that trade credit managed by the OTC platform 504. Stated differently, the configuration of the terms and conditions includes establishing the parameters the seller 502 is willing to offer trade credit to the buyer 501 and how the OTC platform 504 conducts and manages the trade credit transactions.

Information relating to the buyer 501, the seller 502, and the trade credit terms are communicated from the OTC platform 504 to the IPB 506 at a step 516. This information is used by the IPB 506 to perform underwriting. In response to a determination to issue the credit to the buyer 501 for the purchase of goods/services from the seller 502 under the information provided in the step 516, the IPB 506 creates a parent credit account at a step 518. The parent credit account, in an example, can be a credit card (physical or virtual) or the underlying credit card account. As provided herein, the parent credit card account is a primary account referencing the agreed trade credit between the buyer 501 and the seller 502. The parent credit account may be associated with a credit limit for the relationship between the buyer 501 and the seller 502. In the earlier example of a buyer desiring to buy computers from a seller, the parent credit account may be authorized for $1 million dollars of trade credit for the buyer to purchase up to $1 million of computer equipment from the seller with the IPB 506 providing funds to the seller while also collecting funds from the buyer.

At a step 520, the IPB 506 creates 31 sub accounts to the parent account, which will be referred to as child accounts. While any number of child accounts may be created at the step 520, the 31 child accounts provide a separate child account to be associated with each possible day in a given month. Having a discrete child account per possible day in a month allows for all purchases made by the buyer 501 from the seller 502 on a specific day to be captured on a specific child account that will be determined to be used for a particular day payment is to be received under the trade credit program. By consolidating all purchases made on a specific day on a specifically associated child account for that day, all purchases can be segregated to a card having a payment date that satisfies the terms agreed to by the buyer 501 and the seller 502 and as managed by the OTC platform 504.

The aggregate credit available to the child accounts is equivalent to or less than the credit line established for the parent account. However, since the child credit accounts providing a rolling payment schedule across the month, it is contemplated in an example that the available credit under the credit line is fluid with payment of statements relating to each child account on sequential days. Therefore, the underwriting discussed above is focused, in an example, on the parent account. The child accounts are then issued drawing on the parent account credit line.

Focusing on the child account concept, it is contemplated that a first child account is associated with the first day of the month, a second child account is associated with a second day of the month, a third child account is associated with the third day of the month, and so on. As such, herein when referencing the first child account it refers to purchases made on the first day of the month. It is understood that the child accounts and their identifiers (e.g., account number, card number, etc.) are not limited in any manner in the order and mapping between the day of the month and the child account reference/number. For example, the account number associated with a first child account may be greater than an account number associated with a second child account—even with the larger account number being associated with an earlier day in the month.

Each child account issued by the IPB 506 at the step 520 is an active account, similar to an active credit card. Stated differently, in a traditional credit card application process, the IPB 506 would issue a single account having a card. In the contemplated trade credit virtual card arrangement the IPB 506 issues 32 different accounts and cards (virtual or physical). For example, the parent account may include a physical card that is used for in-person purchases, which is a first of the 32 accounts. The purchase with the parent account is communicated to the OTC platform 504 that will determine which of the remaining 31 child accounts is the appropriate account for the purchase to be charged against based on the date of the purchase. While the parent account was used at the point of sale by the buyer 501, the OTC platform 504 translates the purchase to the appropriate child account associated with the parent account used at the purchase to isolate the purchases based on the day of purchase, for example. The translation results in charging the purchase to the appropriate child account as opposed to charging to the originally used parent account. The parent account, in an example, is merely an identifier of the plurality of child accounts to which the purchase is to be charged. The decision is of which of the plurality of child accounts should be used for the purchase is done by the OTC platform 504 identifying the appropriate child account based on the terms and conditions of the trade credit between the buyer 501 and the seller 502.

The buyer 501 may never have visibility to the specific information relating to the individual child accounts. The child accounts are managed, in an example, by the OTC platform 504. Therefore, while a plurality (e.g., 32) of discrete accounts are created and issued by the IPB 506 in response to a single underwriting request from the OTC platform 504 or the buyer 501, the buyer 501 may only be provided identifying information for the parent account. For this reason, that the child account may not be exposed to the buyer and/or because they fall under the parent account underwriting, the child accounts are referred to as virtual accounts. They are issued credit accounts to the buyer 501, but their use is controlled by the OTC platform 504 to ensure the terms and conditions of the trade credit are appropriately applied (e.g., applying a purchase on a specific day to a child account designated for having charges applied for that specific day). The OTC platform 504, on the other hand, will be provided information for each of the plurality (e.g., parent account and child accounts) of accounts. The issued account information is provided from the IPB 506 to the OTC platform 504 at a step 522.

In response to receiving the account information, the OTC platform 504 registers the accounts in a data store. A mapping between the parent account and each of the child accounts is also maintained in a data store. Further, each of the child accounts is mapped with a discrete day of the month, in an example, in a data store. Therefore, the OTC platform 504 controls and maintains a correlation between the accounts issued by the IPB 506 for the benefit of the buyer 501 to purchase goods/services from the seller 502 on trade credit.

The OTC platform 504, in an example, provides a notification to the seller 502 that a trade credit program is available to the buyer 501 to purchase goods/services over a traditional credit card style transaction while complying with the trade credit terms and conditions. The information providing notice is communicated from the OTC platform 504 to the seller 502 at a step 524.

While not depicted, it is also contemplated that the buyer 501 receives information providing notice of the issued credit account(s). In some examples that notice merely includes information on the parent account and is silent on the specific child accounts under the parent account. The information may include a reference, a token, a virtual card, a physical card, and any other information associated with a traditional credit card issuance. The information may be provided from the OTC platform 504 serving as an intermediary between the IPB 506 and the buyer 501. In an alternative example, the IPB 506 provides the information relating to the notification to the buyer 501.

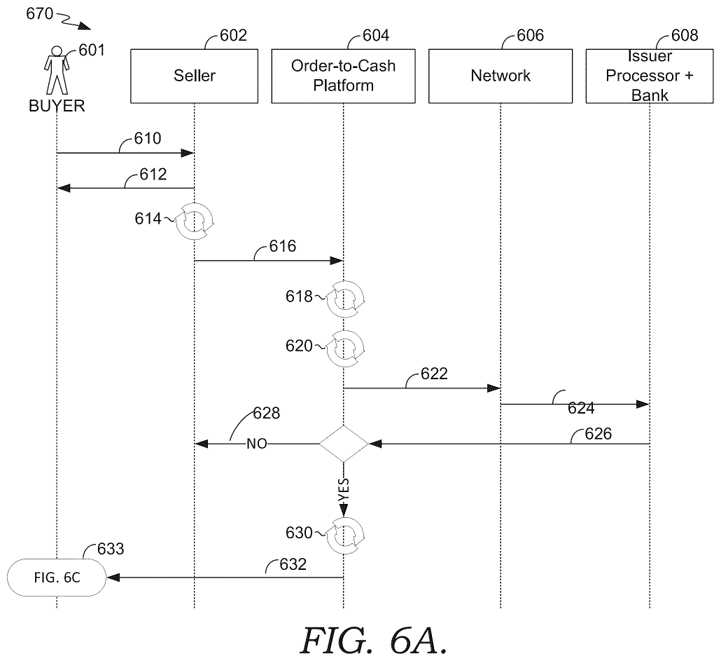

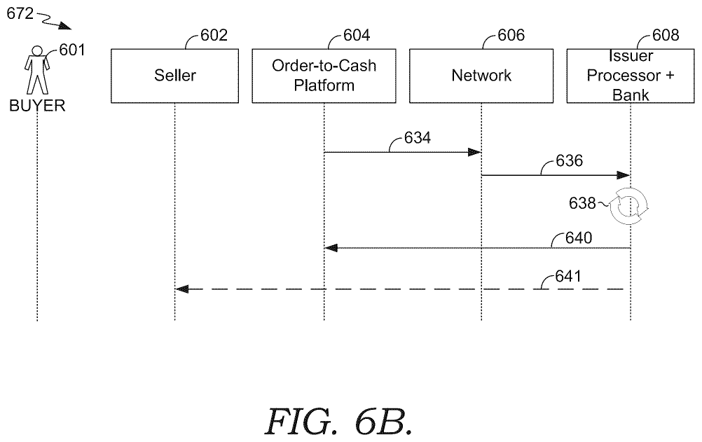

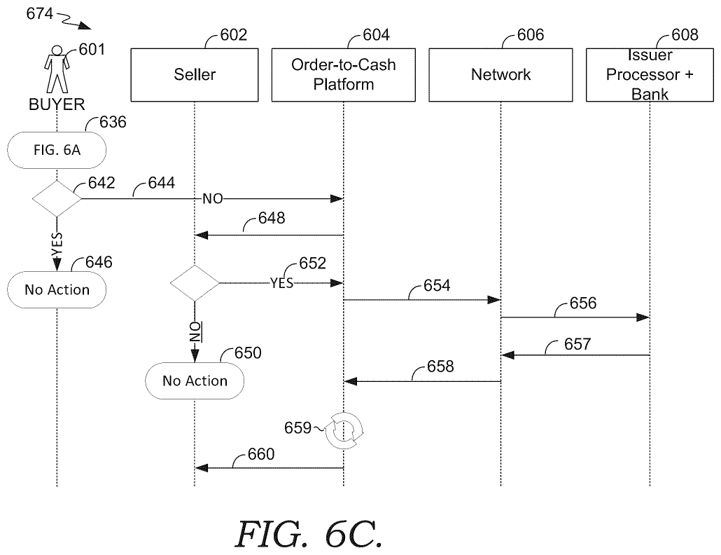

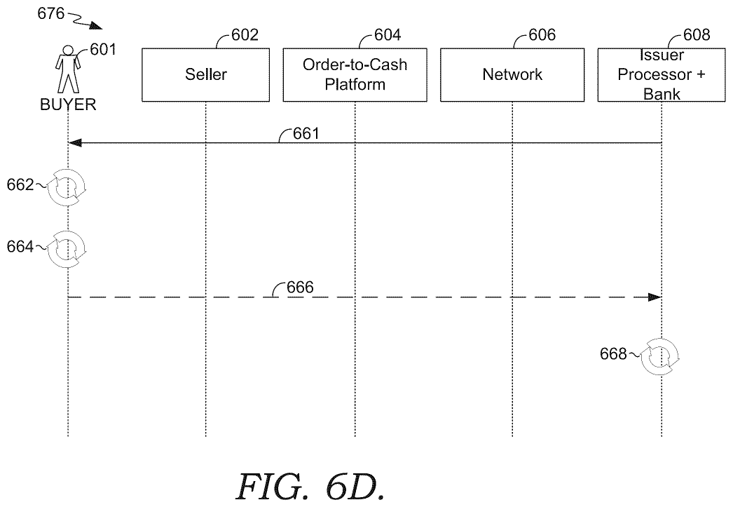

FIG. 6 provides an example of onboarding the buyer 501 to make a purchase from the seller 502 on trade credit over a traditional credit card style environment while still maintain the historic structure of a trade credit interaction having net terms and the like. A step 526 depicts a next logical step in the buying process, which is making a purchase under this environment as depicted in FIG. 6A hereinafter.

Referring now to FIGS. 6A-6D, which contain example operating environments with a method of purchasing using a trade credit program having virtual cards and a traditional credit card buying experience, in accordance with aspects provided herein. It should be understood that the operating environment of FIGS. A-6D is an example that can be performed using the current technology, and that other processes for purchasing on a trade credit platform and variations of the operating environment are contemplated but are not discussed in detail for brevity. The operating environment can be performed by the components of FIG. 1 and provides many of the benefits and advantages discussed herein. As illustrated, the operating environment comprises a buyer 601, a seller 602, an OTC platform 604, a network 606, and an IPB 608.

Having identified the various components of the operating environment in FIGS. 6A-6D, it is emphasized that any additional or fewer components, in any arrangement, may be employed to achieve the desired functionality and are within the scope of the present disclosure. Although, the various components of FIGS. 6A-6D is shown with lines for the sake of clarity, the lines can illustrate a direct path of communication from one component to another or may represent a path having other intermediary components. Further, as discussed above the various components of the operating environment may communicate through one or more networks, directly or indirectly, as provided herein. The buyer 601 is depicted in connection with FIG. 6. The buyer 601 is a purchaser of goods and/or services. The buyer 601 in some examples is a commercial entity, such as a business. The buyer 601 may also be an individual, in some examples.

FIGS. 6A-6D include another explicit component, a network 606, that is not previously discussed in FIG. 5. Because the onboarding process may be accomplished with minimal interaction over an open rails network, such as the network 407 of FIG. 4, a comparable network was not explicitly provided in FIG. 5. However, as will be discussed in FIGS. 6A-6D, the network 606 is relied on for the effective transfer of funds or information relating to funds between parties, such as the IPB 608, the OTC platform 604, the seller 602, and/or the buyer 601.

While the components of FIG. 6A are depicted as single components, the depictions are intended as exemplary in nature and in number and are not to be construed as limiting for all implementations of the present disclosure. Other arrangements and elements (for example machines, interfaces, functions, orders, and groupings of functions, etc.) can be used in addition to or instead of those shown, and some elements may be omitted altogether.

FIG. 6A depicts a process 670 for the buyer 601 to purchase goods/services from the seller 602 using trade credit while operating within a traditional credit card experience. The buyer 601 represent a buyer that was previously on boarded to a trade credit program facilitated by the OTC platform 604, such as the buyer 501 from FIG. 5 discussed hereinabove. A step 610 represents an order placement between the buyer 601 and the seller 602. The order placement may be a purchase or merely a request for purchase. The order may be made in person, may be made through a portal, or through any other business-to-business context. A step 612 represents the delivery of the purchased goods/services from the seller 602 to the buyer 601. Delivery may be physical delivery, shipping, transferring, or otherwise conveying the purchased good/services.

The purchase may be accomplished like a traditional purchase using a traditional credit account. For example, account information such as an account number, a personal identification number, a card verification value (CVV), a card security code (CSC), and/or the like may be supplied to the seller 602. This may be accomplished through a physical credit card being read by the seller 602, it may include a transmission of a virtual credit card, it may be through the communication of information. Regardless of how the purchase is effected, the result is that a unique account identification related to the buyer 601 is provided to the seller 602 that identifies an account maintained by the OTC platform 604 for use in connection with a trade credit purchase option.

At a step 614 the seller 602 updates data stores with information related to the purchase. The information may be updated in an enterprise resource planning (ERP) platform, an order management system (OMS), and/or the like. This data may include SKU-level details relating to the purchase. At a step 616 the seller 602 communicates information to the OTC platform 604 relating to invoice data. The invoice data may include purchase information, purchase date, SKU-level data, data from the ERP/OMS, and/or other information that facilitates the creation of invoices specific for the purchase. The information conveyed at the step 616 may be an automated export that occurs in response to the purchase or another trigger. The information conveyance at the step 616 may be accomplished without human intervention, without manual data entry, and/or without friction-creating intervention.

FIG. 6A at step 614 is an example where a validation of available credit for the buyer 601 by the seller 602 does not occur prior to the transaction between the buyer 601 and the seller 602 completing. In a contemplated alternative that is not explicitly depicted, the seller 602 validates that the buyer 601 has credit available to complete a transaction. In this latter example, it is contemplated that the functions and operations of step 612 are performed prior to the completion of the step 612. Stated differently, the present disclosure supports validating that the buyer 601 has credit is available prior to the completion of a transaction (e.g., deliver as provided in step 612). In an example where the authorization is returned in the negative (e.g., insufficient credit available), the OTC platform 604 can instruct the seller 602 to seek alternative payment solutions from the buyer 601

As provided above, it is contemplated that the SKU-level data, in an example, also include VAT amounts. The inclusion of VAT amount allows for the trade credit virtual card concept to provide a mechanism for recognizing VAT amounts to limit tax exposure, such as through appropriate tax deduction options with a data-rich invoice as support. As discussed above, in some jurisdictions the VAT amounts may be deducted from taxes if specifically included in an invoice and/or statement. However traditional credit card statement fail to specifically break out VAT in the statement and therefore the traditional credit card statements are not useful, in some situations, for documenting the VAT amounts previously paid so that those previously paid VAT amounts can be appropriately accounted for in determining VAT liability for further sales. In the present concept, the inclusion of VAT information when communicating from the seller 602 to the OTC platform 604 allows for the VAT amounts to be included in the generated invoice by the OTC platform 604 for a transaction. The inclusion of the VAT information may be beneficial to the buyer 601 in an effort to reduce taxation related to the VAT.

At a step 618, the OTC platform 604 calculates an invoice due date. The calculation evaluates the information received in step 616 and the terms and conditions associated with the trade credit between the buyer 601 and the seller 602. The information received at the step 616 is usable for identifying the appropriate terms and conditions configured at the OTC platform 604, such as that described in FIG. 5 hereinabove. For example, the OTC platform 604 may receive the purchase information (e.g., price, time, SKU-level data, credit card information used for the purchase, specific purchaser information, buyer/seller credentials for the OTC platform) that is then evaluated allowing the OTC platform 604 to query multiple data sets on a plurality of data stores to determine which child account (e.g., also referred to as a virtual card herein) should be selected from a carousel of child accounts under the determined parent account. The selection of the child account is performed by the OTC platform 604 at a step 620.

The determination of the child account at the step 620 ultimately controls the payment date for the purchase as each child card has a payment date unique to that child account. Depending on the terms of the trade credit program implemented, the payment date for a child account may be 30 days, 45 days, or 60 days from the purchase date. In a 30-day buyer terms program for trade credit, a child account for the next day may be selected. Providing a real example, consider a purchase made on Jun. 20, 2024. In a 30-day buyer terms the 21^{st} child account will receive the purchase, with a statement sent on Jun. 21, 2024 to the buyer 601 and having a statement due (e.g., payment) on Jul. 20, 2024. In a 45-day buyer terms program the 5^{th} child account (the 15^{th} account following the 21^{st} account—with a return to the 1^{st} child account after the 31^{st} child account), which will receive the purchase, with a statement sent on Jul. 5, 2024 to the buyer 601 and having a statement due (e.g., payment) on Jul. 6, 2024. In a 60-day buyer terms program the 20^{th} child account (the 30^{th} account following the 21^{st} account—with a return to the 1^{st} child account after the 31^{st} child account), which will receive the purchase, with a statement sent on Jul. 20, 2024 to the buyer 601 and having a statement due (e.g., payment) on Aug. 19, 2024. This determination by the OTC platform 604 enforces the net terms of the trade credit program being exercised. Other buyer terms are available and the current process is not limited to the discussed 30, 45, and 60-day terms. Instead, the current system is capable of accommodating any temporal terms contemplated under a trade credit program.

In response to selecting the child account and the statement due date the OTC platform 604 will trigger an authorization on the trade credit account associated with the selected child account of the buyer 601, as depicted in a step 622. In this step, the OTC platform 604 is functioning as a virtual merchant to the network 606 on behalf of the seller 602, which is the actual merchant in this purchase. The network 606 operates in a traditional credit card style transaction with the authorization received in the step 622 as the logic applied by the OTC platform 604 enforces the net terms of the trade credit program. As such, at a step 624 the network 606 communicates the authorization to the IPB 608. The step 624, in an example, also operates in a traditional manner as the OTC platform 604 applied the logic to enforce the net terms of the trade credit program. The authorization information in step 622 and step 624 may include a reference to the specific purchase transaction that is useable by the OTC platform 604 when generating an invoice for the purchase following a successful authorization. The reference is a data type capable of being communicated through the network 606 and acts as a key for identifying a greater scope of information maintained at the OTC platform 604, such as SKU-level data. The reference may be a number or identifier of an invoice representing the specific transaction. The invoice is generated by the OTC platform 604. The reference, in an example, is included in a statement generated by the IPB 608 and provided to the buyer 601.

The authorization occurring at the network 606 and IPB 608 are traditional authorization steps for a credit transaction. It is contemplated that another layer of authorization may be conducted prior to triggering the authorization at the step 622. The OTC platform 604 may perform a first layer authorization based on the trade credit program terms and conditions. For example, depending on the specific purchaser for the buyer 601, such as a name, title, level of responsibility, and the like, the buyer 601 may dictate different levels of access to the available credit. For example, the purchaser may be a procurement specialist at the buyer 601 that is authorized to make up to $50,000 in purchases per day. The OTC platform 604, in an example, validates the current purchase falls within the rules applied to the specific purchaser of the buyer 601. If the first level of authorization, in this example, is satisfied, the OTC platform 604 may then trigger the authorization to the network 606 at the step 622. This first layer authorization may be based on any rules contemplated by the buyer 601.

At a step 626, the results of the authorization are communicated from the IPB 608 through the network 606 to the OTC platform 604. If the authorization was not successful, the OTC platform 604 notifies the seller 602 and requests alternative payment options at a step 628. If the authorization is successful, the OTC platform 604 generates an invoice at a step 630. As discussed above, the authorization may have included a specific reference related to the purchase. That reference is associated with the invoice generated at the step 630. For example, the reference may be associated with a pro-forma invoice number available for inclusion with the information communicated at the step 622 even though the invoice is not generated until the step 630. That reference may return through the network 606 with confirmation of authorization from the IPB 608. The reference may then be relied on by the OTC platform 604 to pull a richer set of data to be included in the invoice. This SKU-level data may be pulled from a data store of the OTC platform 604 and/or from the seller 602, in an example. As provided above, the reference in the authorization may serve as a key to mapping the specific authorization confirmation with SKU-level data of the purchase. In this way, a rich invoice may be generated for a credit card style transaction. That invoice is communicated to the buyer 601 at a step 633. The invoice in an example, is not a statement. The invoice is a notification of the purchase, but not a demand for payment. Instead, a statement will be generated and provided later according to the trade credit terms as enforced by the child account selected for the purchase.

In an alternative example, an invoice reference is attached or inserted to the invoice at the step 630. The invoice reference functions like the previous authorization reference, and in an example is functionally the same. The invoice reference may be included at a time when the purchase is submitted as a charge to the IPB 608. As will be detailed in connection with FIG. 6B hereinafter.

A step 633 is provided to connect the communicating of the invoice to the buyer 601 with next steps in the sequence that will be discussed in connection with FIG. 6C.

Prior to turn to FIG. 6C, FIG. 6B provides for days sales outstanding (DSO) process 672 according to the trade credit program leveraged, in accordance with aspects herein. The trade credit program may establish a DSO of 2 days, which represents when a charge is submitted to the network 606 from the OTC platform 604 at a step 634. The buyer is able to set the DSO they desire for the trade credit program. Fees associated with the transaction may increase with extended DSO timelines. Therefore, the longer the DSO the greater fee charged by the parties to the transaction. The charge information communicated at the step 634 may include the invoice reference previously associated with the invoice. The invoice reference is capable of providing a key between the charge passing through the network 606 and the IPB 608 to identify a specific purchase and associated invoice for reconciliation purposes. The charge information is communicated to the IPB 608 at a step 636. At a step 638 the IPB 608 determines the charge is to be paid through a traditional settlement process. The network 606 and the OTC platform 604 receive, at a step 640, confirmation of the payment to the seller 602.

In a first example, the confirmation at the step 640 also includes the funds transferred to the OTC platform 604 for distribution to the seller 602. In an alternative example, the confirmation at the step 640 is merely an informational confirmation for use by the OTC platform 604 to update records associated with the invoice having the invoice reference contained in the confirmation. In this example, the IPB 608 transfers the funds to the seller 602 through the network 606, like a traditional credit card process. While step 641 is illustrated passing through the OTC platform 604, it is contemplated that the OTC platform is not included in the funds transfer process represented by the step 641. Therefore, in this example the line representing the step 641 should bypass the OTC platform 604.

Turning to FIG. 6C, which represent an invoice approval process 674 by the buyer as an optional step following FIG. 6A, in accordance with aspects hereof. As a reference, a step 636 is provided as a waypoint from FIG. 6A. At a decision 642, the buyer 601 determines if the invoice received for the purchase is accepted. If accepted, no actions are taken for the purposes of FIG. 6C, as provided in a block 646. However, if the invoice is not accepted at the decision 642, a declination of the invoice is communicated to the OTC platform 604 at a step 644. This causes the OTC platform to register a dispute for the invoice, which may be identified by the invoice reference associated with the invoice under dispute. At a step 648, the OTC platform 604 notifies the seller 602 of the dispute. The seller 602 choose to not accept the dispute, which will trigger an adjudication process at a block 650. The seller 602 may alternatively accept the dispute and notify the OTC platform 604 of the acceptance at a step 652. In response to the accepted dispute, the OTC platform 604 triggers a chargeback through the network 606 at a step 654. The charge back is routed from the network 606 to the IPB 608 at a step 656. As a result of the chargeback request, the IPB 608 at a step 657 issues a charge back that is passed through the network 606.

In a first example the chargeback is routed to the OTC platform 604 at a step 658. The OTC platform 604 processes the charge back request at a step 659 to update the data stores with the charge back information. At a step 660 the chargeback information is communicated to the seller 602. In an alternative example, the chargeback is also communicated from the network to the seller 602 without intervention from the OTC platform 604. It is contemplated that both the seller 602 and the OTC platform 604 may also (or alternatively) received notice of the charge back from the network 606.

Turning to FIG. 6D, which represent a process 676 of providing a statement to the buyer 601 for a purchase, in accordance with aspects hereof. The IPB 608 generates the statement for a child account and communicates the statement to the buyer 601 at a step 661. The statement includes the invoice reference associated with each charge listed on the statement. This reference allows for SKU-level data to be retrieved and evaluated for each item on the statement. This level of information is helpful as the buyer 601 reconciles the statement to the accounts payable at a block 662 for the buyer 601. The buyer 601 is then capable of authorizing the paying of the statement at a block 664. In an example, the funds to pay the IPB 608 for the approved statement are funded in a traditional manner through the network 606 as depicted by a step 666. The IPB 608 updates the balances and information for the child account and/or the parent account at a block 668.

Embodiments described above are combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present disclosure is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having,” or variations thereof, has the same broad meaning as the word “comprising,” and the word “accessing,” or variations thereof, comprises “receiving,” “referencing,” or “retrieving.” Further, the word “communicating,” or variations thereof, has the same broad meaning as the word “receiving,” or “transmitting” facilitated by software or hardware-based buses, receivers, or transmitters using communication media. Also, the word “initiating” or “invoking,” or variations thereof, has the same broad meaning as the word “executing” or “instructing” where the corresponding action can be performed to completion or interrupted based on an occurrence of another action.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of a detailed discussion above, embodiments of the present disclosure described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present disclosure may generally refer to the distributed data object management system and the described schematics, it is understood that the techniques described may be extended to other implementation contexts.

From the foregoing, it will be seen that the present disclosure may be well adapted to attain all the ends and objects described above, including other advantages that are obvious or inherent to the structure. It will be understood that certain features and sub combinations are of utility and may be employed without reference to other features and sub combinations. This is contemplated by and is within the scope of the claims. Since many possible embodiments of the described technology may be made without departing from the scope, it is to be understood that all matter described herein or illustrated the accompanying drawings is to be interpreted as illustrative and not in a limiting sense.

What is claimed is:

1. One or more computer storage media storing computer-readable instructions that when executed by one or more processors, cause the one or more processors to perform operations for a trade credit purchase, the operations comprising:
receiving, by an order-to-cash (OTC) platform, a request to authorize a purchase from a seller by a buyer, the buyer having a trade credit account with the OTC platform;
determining based on a query of a database. by the OTC platform, to which of a plurality of child accounts the purchase should be authorized;
communicating, from the OTC platform, a request for authorization of the purchase using an open loop payment system to a bank;
receiving, by the OTC platform, a set of transaction details for the authorized purchase;
automatically generating, by the OTC platform, based on the set of transaction details, an invoice; and
communicating, by the OTC platform, the invoice to the buyer.

2. The media of claim 1 further comprising determining a statement date for the purchase, wherein the statement date is used to determine which of the plurality of child accounts the purchase should be authorized.

3. The media of claim 1, wherein the plurality of child accounts comprises 31 accounts.

4. The media of claim 1 further comprising receiving an application for a trade credit account from the buyer.

5. The media of claim 4 further comprising requesting a bank to underwrite the buyer.

6. The media of claim 4 further comprising requesting the bank to generate a parent account and the plurality of child accounts for the buyer.

7. The media of claim 1 further comprising inserting an invoice reference in the invoice, wherein the invoice reference is also communicated to the bank for inclusion in a statement generated by the bank.

8. The media of claim 1 further comprising authorizing a purchaser at the buyer based on credentials of the purchaser and rules provided by the buyer to the OTC platform.

9. The media of claim 1 further comprising receiving a dispute of the invoice from the buyer and notifying the seller of the invoice dispute.

10. The media of claim 9 further comprising triggering a chargeback request to the bank for the seller.

11. The media of claim 1, wherein determining which of the plurality of child accounts should be authorized further comprises determining a number of days associated with a trade credit program associated with the purchase.

12. The media of claim 1 wherein each of the plurality of child accounts is associate with a different day of a month.

13. The media of claim 1, wherein a set of transaction data comprises stock keeping unit level data.

14. The media of claim 13, wherein the set of transaction data comprises an itemized list of purchased items.

15. The media of claim 13, wherein the stock keeping unit level data comprises value added tax information.

16. The media of claim 13, wherein the set of transaction data comprises a uniform resource locator associated with the purchase and the seller.

17. A system comprising:
at least one processor;
one or more computer storage media storing computer-readable instructions thereon that, when executed by the at least one processor, cause the at least one processor to perform operations comprising:
receiving, by an order-to-cash (OTC) platform, a request to authorize a purchase from a seller by a buyer, the buyer having a trade credit account with the OTC platform;
determining based on a query of a database, by the OTC platform, to which of a plurality of child accounts the purchase should be authorized;
communicating, from the OTC platform, a request for authorization of the purchase using an open loop payment system to a bank;
receiving, by the OTC platform, a set of transaction details for the authorized purchase;
automatically generating, by the OTC platform, based on the set of transaction details, an invoice; and
communicating, by the OTC platform, the invoice to the buyer.

18. The system of claim 17, wherein determining which of the plurality of child accounts should be authorized further comprises determining a number of days associated with a trade credit program associated with the purchase.

19. The system of claim 17, wherein each of the plurality of child accounts is associate with a different day of a month.

20. A computer-implemented method, the method comprising:
at least one processor;
one or more computer storage media storing computer-readable instructions thereon that, when executed by the at least one processor, cause the at least one processor to perform operations comprising:
receiving, by an order-to-cash (OTC) platform, a request to authorize a purchase from a seller by a buyer, the buyer having a trade credit account with the OTC platform;
determining based on a query of a database, by the OTC platform, to which of a plurality of child accounts the purchase should be authorized;
communicating, from the OTC platform, a request for authorization of the purchase using an open loop payment system to a bank;
receiving, by the OTC platform, a set of transaction details for the authorized purchase;
automatically generating, by the OTC platform, based on the set of transaction details, an invoice; and
communicating, by the OTC platform. the invoice to the buyer.
